(19) United States
(12) Patent Application Publication
(10) Pub. No.: US 2011/0200729 A1
(43) Pub. Date: Aug. 18, 2011

(54) GROUND FOOD PREPARATION ASSEMBLY AND METHODS

(76) Inventor: Ty Caswell, Zimmerman, MN (US)

(21) Appl. No.: 13/029,002

(22) Filed: Feb. 16, 2011

Related U.S. Application Data
(60) Provisional application No. 61/305,489, filed on Feb. 17, 2010.

(51) Int. Cl. A47J 43/28; A23P 1/00

(52) U.S. Cl. 426/518; 99/537

(57) ABSTRACT

A food preparation assembly includes first and second food preparation members each comprising a pad portion, a handle portion extending from a first end of the pad portion, and a claw portion extending from a second end of the pad portion. The pad portions define an edge surface configured to chop food. The claw portion is configured to pull apart food. The pad portion defines a pad surface to compress food between the pad portions of the first and second food preparation members.

### CROSS-REFERENCE TO RELATED APPLICATION

This application claims the benefit of the filing date of U.S. Provisional Application No. 61/305,489, filed Feb. 17, 2010, and entitled GROUND FOOD PREPARATION ASSEMBLY AND METHODS, the disclosure of which is incorporated, in its entirety, by reference.

### TECHNICAL FIELD

The present disclosure generally relates to food preparation devices and assemblies, and more particularly relates to devices, assemblies and methods for preparation of food such as ground meat.

### BACKGROUND

Some types of food preparation include breaking down a single food article into smaller pieces. In some cooking scenarios, the food article is made into smaller pieces concurrently with cooking of the food article in order to reduce the amount of time required for preparing the food article for eating. Typically, a cooking utensil such a spoon or spatula is held in one hand by a user to cut or chop the food article that is being cooked in a heated pan that is held by the other hand of the user. When using a single utensil held by a single hand of the user, breaking the food article into smaller pieces can be time consuming and frustrating.

An example food article that is commonly broken into smaller pieces while being cooked is ground meat. Typically, the larger the piece of ground meat being cooked, the greater the amount of time required to thoroughly cook the meat (i.e., to 160° F., which temperature is suggested to kill bacteria such as e-coli). In order to reduce the cooking time required for ground meat and portion the ground meat into a size required by a recipe (i.e., a casserole) a user may cut the single piece of ground meat into multiple pieces while the ground meat is positioned in a heated pan that is held in place by the user. Breaking the ground meat into a small sized pieces with a desired consistency in size can be difficult using a spatula or other common cooking utensils.

### SUMMARY

The present disclosure relates to food preparation devices, assemblies and related methods. In one example, a food preparation assembly provides an improved way to cook (i.e., brown) and finely crumble ground meat (e.g., ground beef, turkey, lamb, pork) in a reduced time period. The food preparation assembly may be particularly effective at creating fine or super fine meat crumbles that are desired for recipes such as casseroles and hamburger helper type dishes. Typically, finely crumbled meat cook faster and more thoroughly, which can reduce the risk of e-coli and other bacteria in the prepared food.

The example food preparation methods may provide a two-handed operation of the food preparation assembly using separate food preparation members that are detached from each other. Each of the food preparation members can be used independently or in conjunction with another food preparation member to prepare a food article by breaking down the food article into smaller pieces prior to, during, or after cooking of the food article. The method steps involved in the food preparation method using the food preparation assembly may generally be defined as 1) clawing or pulling, 2) chopping or cutting, and 3) compressing or crumbling. Each step may be conducted in sequence to reduce the food article into smaller and smaller sizes. The shape and size of the food preparation members of the assembly may designed to provide improved easy of use and effectiveness in reducing the size of individual food portions of the food article.

Another aspect of the present disclosure is directed to a food preparation assembly that includes first and second food preparation members. The first food preparation member includes a first pad portion, a first handle portion extending from a first end of the first pad portion, and a first claw portion extending from a second end of the first pad portion. The second food preparation member includes a second pad portion, a second handle portion extending from a first end of the second pad portion, and a second claw portion extending from a second end of the second pad portion. The first and second pad portions each define a chopping edge. The first and second claw portions are cooperatively operable to pull apart food. The first and second pad portions are cooperatively operable to compress food between the first and second pad portions.

The above summary of the present invention is not intended to describe each embodiment or every implementation of the present invention. The attached FIGS. and the detailed description that follow more particularly exemplify examples embodiments including inventive aspects of the present disclosure.

### BRIEF DESCRIPTION OF THE DRAWINGS

FIG. 1 is a side view of an example food preparation member in accordance with the present disclosure.

FIG. 2 is a top view of the food preparation member of FIG. 1.

FIG. 3 is a bottom view of the food preparation member of FIG. 1.

FIG. 4 is a front view of food preparation member of FIG. 1.

FIG. 5 is a rear view of the food preparation member of FIG. 1.

FIG. 6 is a top perspective view of the food preparation member of FIG. 1.

FIG. 7 is a bottom perspective view of the food preparation member of FIG. 1.

FIG. 8 is a bottom perspective view of another example food preparation member in accordance with the present disclosure.

FIG. 9 is a top perspective view of a food article positioned in a cooking pan.

FIG. 10 is a top perspective view of a food preparation assembly being two of the food preparation members of FIG. 1 used to claw or pull apart the food article.

FIG. 11 is a top perspective view of the food preparation assembly of FIG. 10 further pulling apart or clawing the food article.

FIG. 12 is a top perspective view of the food article broken into a plurality of food portions.

FIG. 13 is a top perspective view of the food preparation assembly of FIG. 10 arranged to chop or cut the food portions.

FIG. 14 is another top perspective view of the food preparation assembly of FIG. 10 cutting or chopping the food portions.

FIG. 15 is a top perspective view of the food portions of the food article having a smaller size.

FIG. 16 is a top perspective view of the food preparation assembly of FIG. 10 arranged to compress or crumble the food portions.

FIG. 17 is another top perspective view of the food preparation assembly of FIG. 10 arranged to compress or crumble the food portions.

FIG. 18 is a top perspective view of the food portions in an even smaller size.

### DETAILED DESCRIPTION

The present disclosure is directed to food preparation devices and assemblies and related methods of preparing food using the same. The devices, assemblies and methods disclosed herein and referenced in the attached figures provide for preparation of food articles such as ground meat. The devices and assemblies may be useful to perform multiple functions related to the food articles such as clawing or pulling, cutting or chopping, and compressing or crumbling of portions of the food article to reduce the size of the food portions.

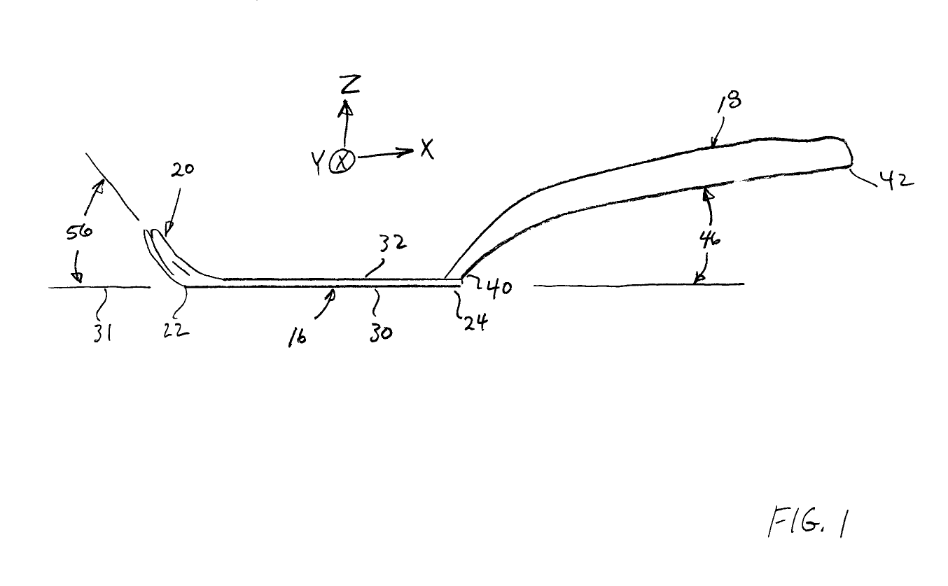

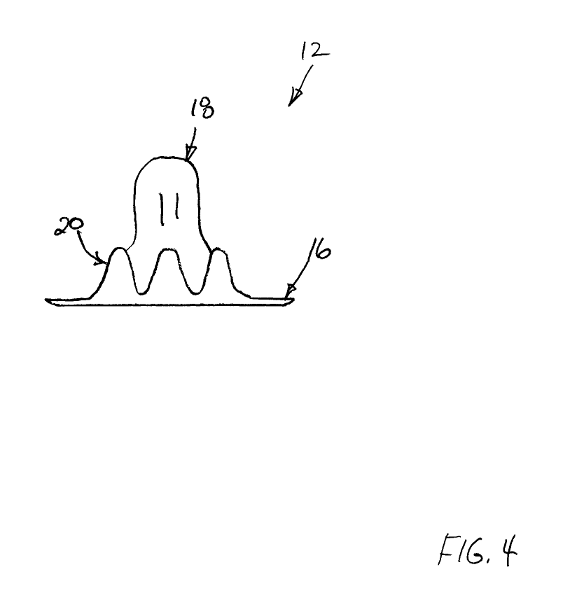

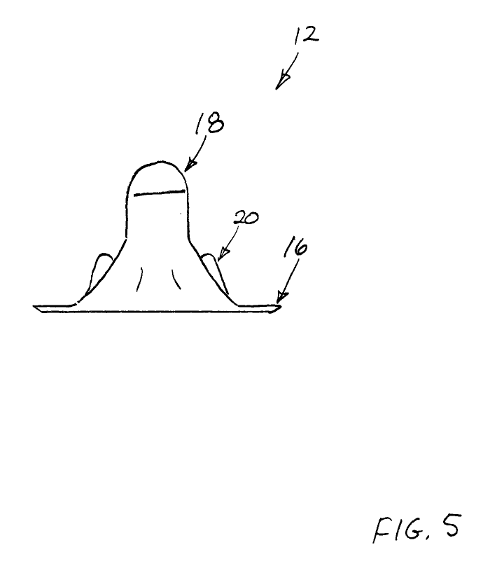

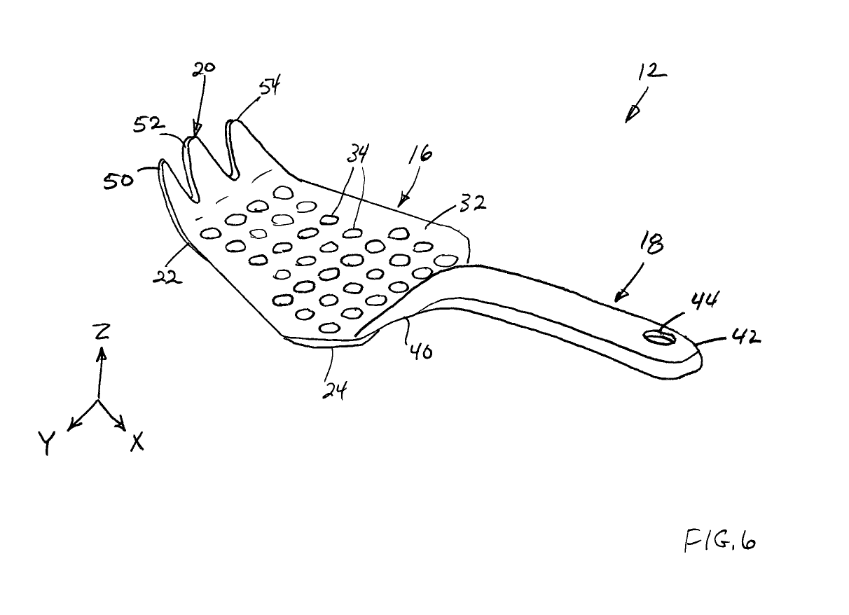

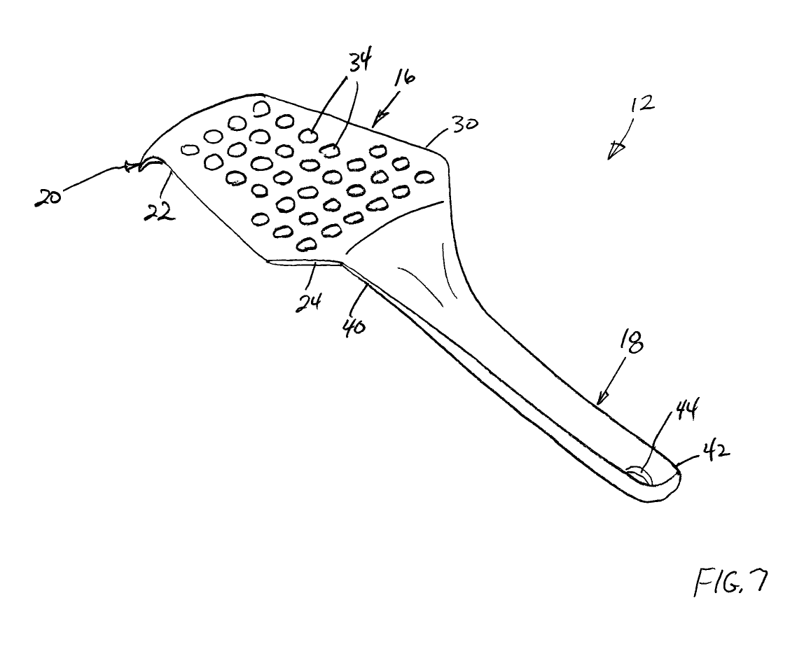

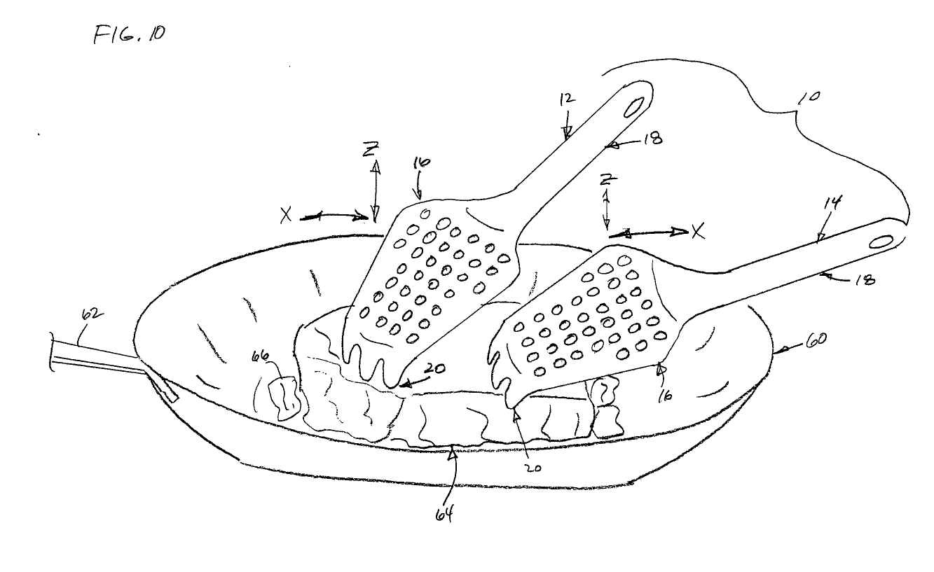

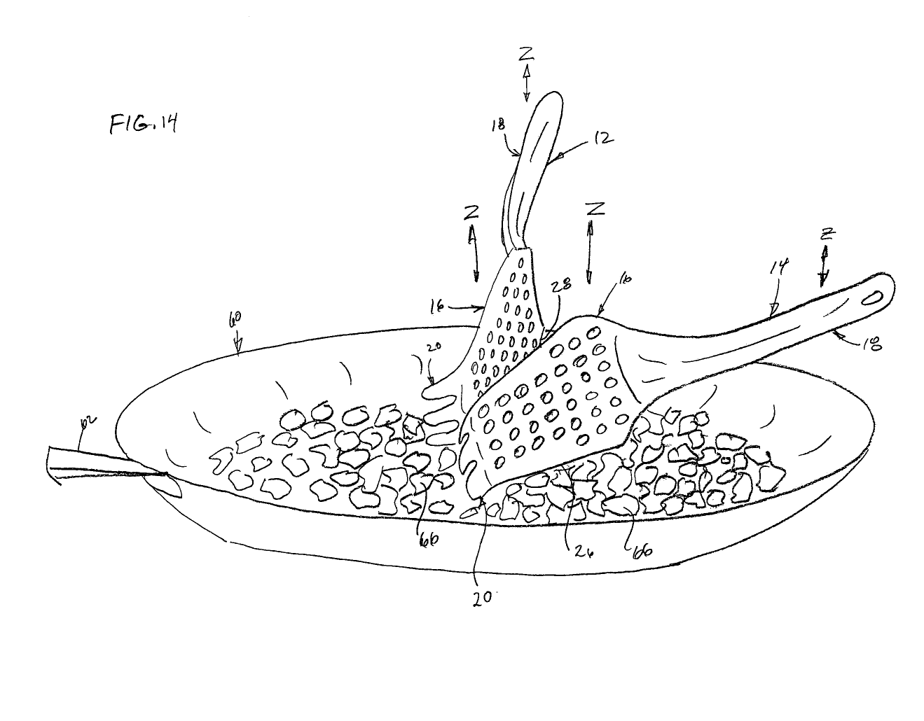

Referring to FIGS. 1-7, an example food preparation member of a food preparation assembly is shown and described. Typically, a pair of the food preparation members 12 are used in combination as part of the food preparation assembly. FIGS. 10-18 described in further detail below illustrate a food preparation assembly 10 used to break down a food article 64 into smaller food portions 66 prior to, during, or after cooking of the food article. The food preparation assembly includes first and second food preparation members 12, 14. The food preparation members 12, 14 may include at least some of the same features and functions described below with reference to the food preparation members 12, 112 shown in FIGS. 1-8. In some arrangements, the food preparations members 12, 14 may include different features and may be sized and shaped identically or with many differences.

The example food preparation member 12 includes a pad portion 16, a handle portion 18 and a claw portion 20. While each of the pad portion 16, handle portion 18, and claw portion 20 are included in each of the food preparation members shown in the attached drawings, other embodiments are possible that exclude these features to provide different functionality.

The pad portion 16 includes first and second ends 22, 24, first and second side edges 26, 28, a pad surface 30, a rear surface 32 and a plurality of apertures 34. The claw portion 20 is positioned at and extends from the first end 22. The handle portion 18 is positioned at and extends from the second end 24. The first and second side edges 26, 28 extend between the first and second ends 22, 24 along opposite sides of the pad portion 16.

The pad surface 30 may be generally planer and define a pad plane 31. The handle portion 18 and claw portion 20 may extend from the pad portion 16 at an angle relative to the pad plane 31 (see FIG. 1). In one example, the handle portion 18 and claw portion 20 may extend in generally opposite directions relative to the pad portion 16. The handle portion 18 and claw portion 20 may extend away from the pad plane 31 in generally the same direction so that the handle portion 18 and claw portion 20 are positioned spaced apart from the pad plane 31. The handle portion 18 may be arranged at a handle angle 46. The claw portion 20 may extend at a claw angle 56. The angles 46, 56 are typically greater than 0° and less than about 90°. In one arrangement, the angle 46 may be in the range of about 10° to about 45°, and more preferably in the range of about 15° to about 20° degrees. The angle 56 may be in the range of about 20° to about 60°, and more preferably in the range of about 40° to about 50°.

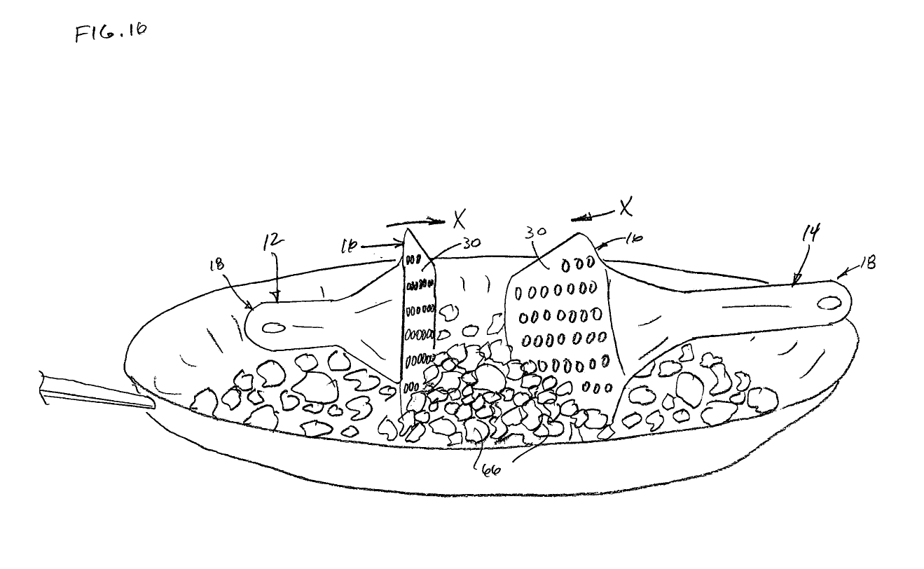

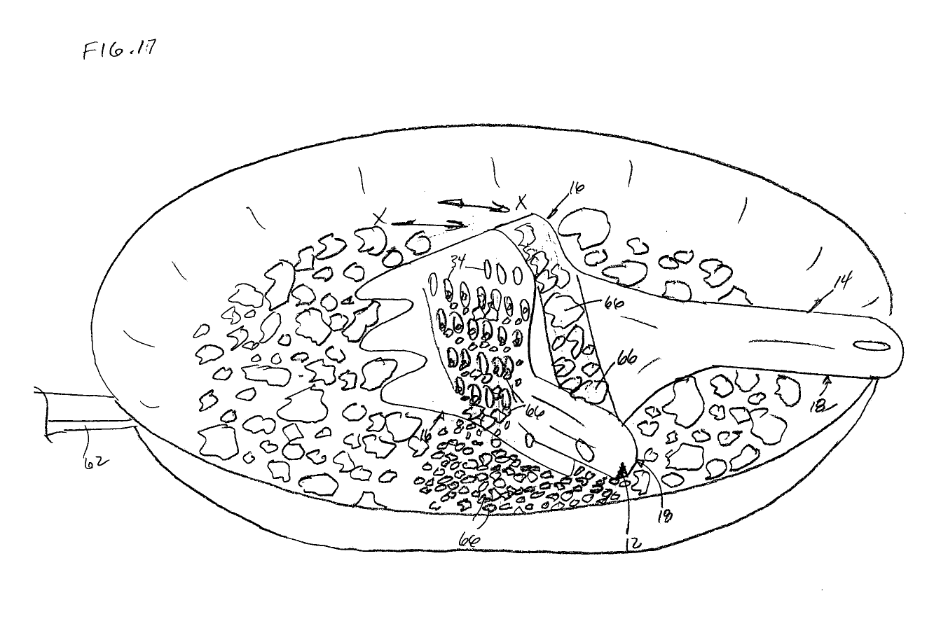

Arranging the handle portion 18 at an angle 46 greater than 0° may provide a space between the pad plane 31 and the handle portion 18 for a user's fingers to be positioned while grasping the handle portion 18. When the pad surfaces 30 of the first and second food preparation members 12, 14 are brought into contact with each other when compressing a food portion 66 as shown in FIGS. 16 and 17, the user's fingers typically do not contact as would otherwise be the case if the angle 46 were closer to 0°. In at least one example, the angle 46 could be smaller or even a negative number and would not cause interference with the user's fingers during use of the food preparation assembly 10 if the food preparation members 12, 14 are rotated about a vertical Z axis so that the handle portions 18 are not aligned overlapping each other.

The angle 56 being greater than 0° may provide advantages when breaking the food article 64 into smaller pieces by not only piercing the food article with the claw portion 20, but also pulling apart the food article once pierced by the claw portion 20 by pulling in the X direction.

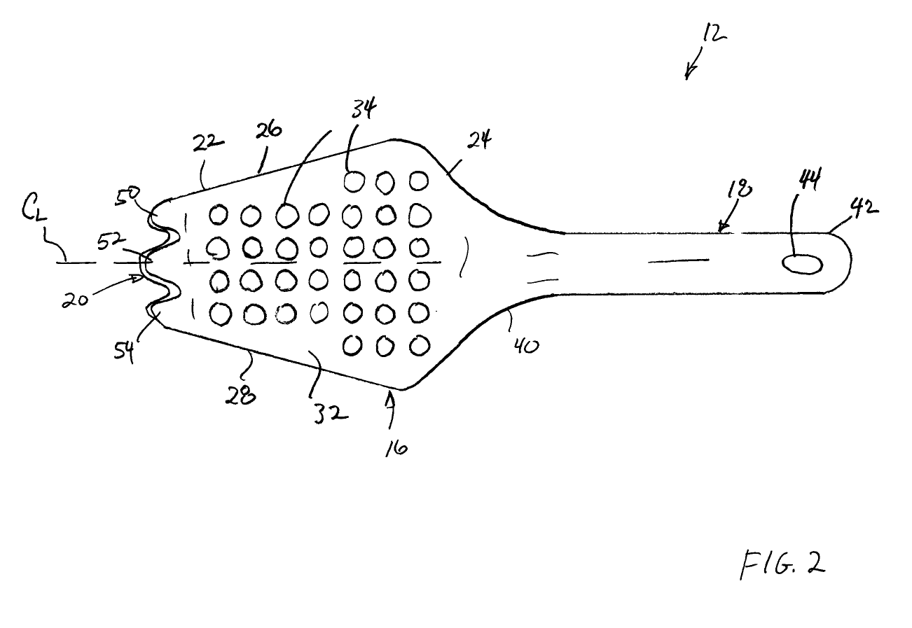

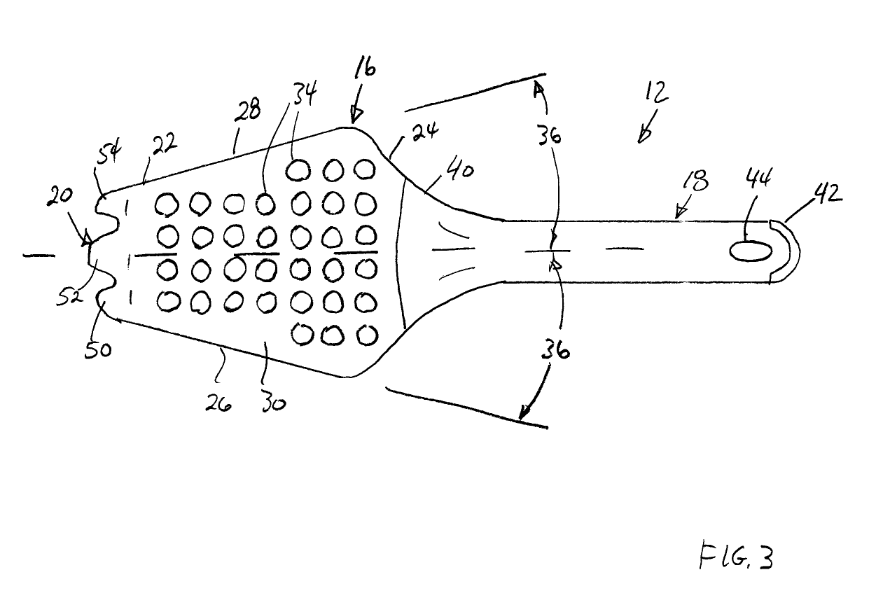

Referring to FIGS. 2 and 3, the pad portion 16 may include a C_{L} extending from the handle portion 18 towards the claw portion 20. The first and second side edges 26, 28 may be arranged at an edge angle 36 relative to the C_{L}. The edge angle 36 may be substantially 0° providing a parallel arrangement of the first and second side edges 26, 28 relative to the C_{L}. In other arrangements, one or more of the edge angles 36 may be greater than 0° and typically less than about 90° so as to arrange the first and second side edges 26, 28 at a non-parallel orientation relative to the Centerₗine. Providing one or more of the first and second side edges 26, 28 at a non-parallel orientation relative to the C_{L} may provide positioning of the handle portion 18 away from the cooking pan while contacting the food article 64 with one of the first and second side edges 26, 28 when chopping or cutting the food article. The greater the edge angle 36, typically the further away the handle portion 18 is moved from the food article and the pan or other cooking device within which the food article 64 is positioned. One example, the edge angle 36 is in the range of about 10° to about 45°, and more preferably in the range of about 15° to about 20°.

The first and second side edges 26, 28 may be defined by a relatively flat surface that extends between the pad surface 30 and rear surface 32 (see FIG. 1). This relatively planer side surface may define a blunt surface used to chop or crush the food article. In at least some arrangements, the distance between the pad surface 30 and rear surface 32 is small enough that the first and second side edges 26, 28 tend to find a cutting surface. In at least some arrangements, the first and second side edges 26, 28 are constructed as a cutting edge with a relatively sharp construction that may be useful in cutting. In at least some arrangements, at least a portion of at least one of the first and second side edges 26, 28 may include serrations, grooves, divets, or protrusions that may provide benefits in chopping or cutting the food article.

The apertures 34 may be defined in a pattern across the pad portion 16. The size and shape of the apertures 34 may vary depending on the size and shape of the pad portion 16 and other variables such as the desired size of the prepared food article after completion of preparation of the food article. In at least one example, the size (i.e., maximum diameter or minimum width dimension) of the apertures 34 may define the minimum or maximum size of the food portion of the food article after preparation of the food article.

Providing at least one aperture 34 and the pad portion 16 may provide additional edge surfaces along either the pad surface 30 or rear surface 32 that may apply a cutting or other applied point or line force to the food article that assists in breaking down the food article into smaller food portions. These edge surfaces defined by the apertures 34 may increase the abrasive or cutting properties along the pad surface 30 and rear surface 32.

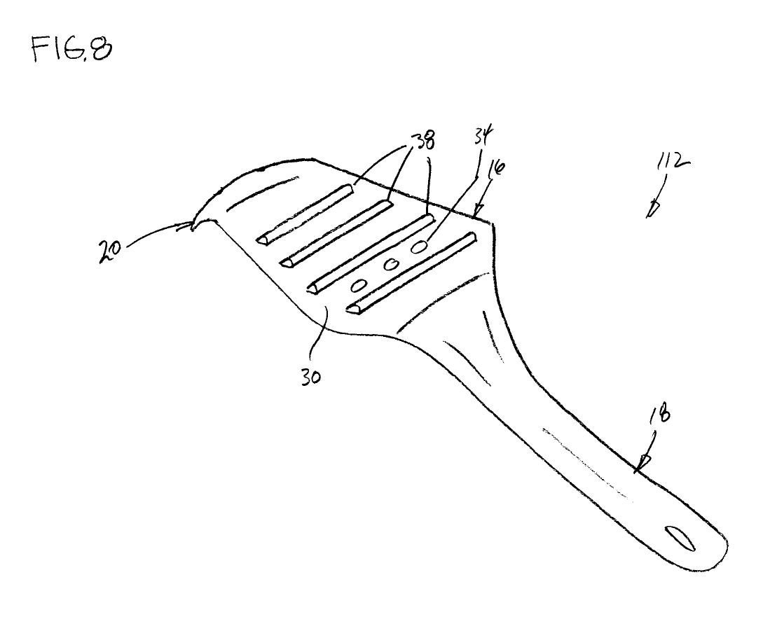

In some arrangements, the apertures 34 are defined only as recesses that extend only partially through the pad portion 16 from the pad surface 30 toward the rear surface 32. In other arrangements, such as the food preparation member 112 shown in FIG. 8, at least one protrusion 38 may be positioned along at least one of the pad surface 30 and rear surface 32. The protrusion 38 may be used alone or in combination with apertures 34, recesses, grooves, or other features that increase the abrasive properties along at least one of the pad surface 30 and rear surface 32. In some arrangements, these features along the pad surface 30 may alter the pad surface 30 so that the pad surface is no longer planer, but rather has waves, dips, grooves, protrusions or other features that effectively change the shape of the pad portion 16.

The handle portion 18 may include first and second ends 40, 42 (see FIG. 1) and an aperture 44. The aperture may be used to help hang the food preparation member 12. Typically, the handle portion 18 is connected to the pad portion 16 at the first and 40.

The handle portion 18 may have a variable curvature along its length between the first and second ends 40, 42. For example, referencing FIG. 1, the handle portion 18 has substantial curvature along a first portion near the first end 40 and then becomes relatively straight or linear for the remaining portion towards the second end 42. Other configurations are possible including, for example, a handle portion 18 that is substantially straight or linear along its entire length from the first end 40 to the second end 42.

The handle portion 18 may include contours that provide improved ergonomics. For example, a plurality of grooves representing a handle grip may be formed or added to the handle portion 18. In other examples, a layer made along an outer surface of the handle portion 18 may be added but includes compressible material such as gel or foam that improves comfort when grasping the handle portion 18. Further the handle portion 18 may have curvature in the lateral direction (i.e., the Y direction shown in FIG. 1) that may make the handle portion 18 easier to use for either a left-handed or right handed person depending on the curvature.

The claw portion 20 may include a plurality of claw members such as the first, second, and third claw members 50, 52, 54 shown in FIGS. 2-7. The claw members 50, 52, 54 may have different shapes and sizes. The claw members 50, 52, 54 may extend at different claw angles 56 relative to the pad plane 31. In some arrangements, at least some of the claw members 50, 52, 54 may extend in a lateral direction Y that extends beyond the first and second side edges 26, 28.

The claw portion 20 may include at least some cutting surfaces that are defined to cut, pull, or rip apart the food article. Providing cutting surfaces along at least portions of claw portion 20 may provide easier insertion of the claw portion 20 into the food article and improve tearing apart of the food article when applying pulling or ripping forces using the first and second preparation members 12, 14.

The claw portion 20 is shown positioned at the first end 22 of the pad portion 16. In other examples, one or more claw members may be positioned along other portions of the pad portions 16, such as along one or more of the first and second side edges 26, 28 or second end 24. Any number of claw members may be used including a single claw member or four or more claw members. In some arrangements, the claw portion 20 may extend at a claw angle 56 that is less than 0° so as to extend in an opposite direction relative to the pad plane 31.

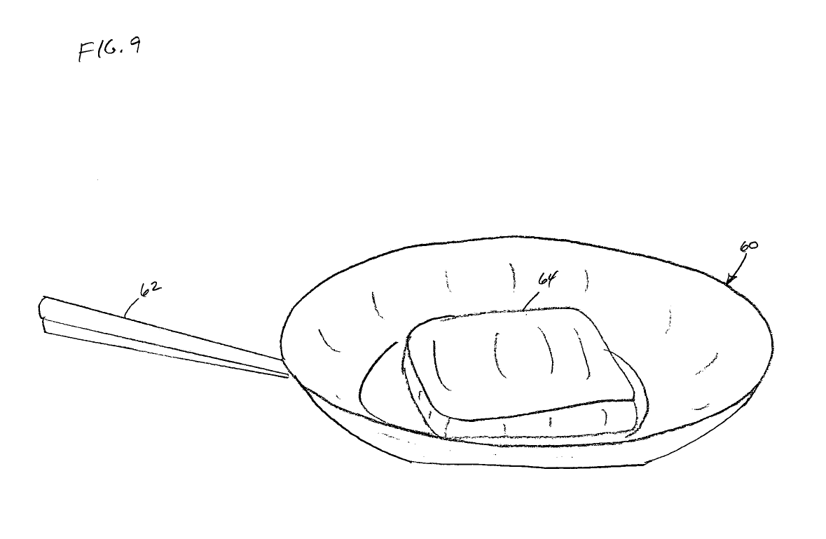

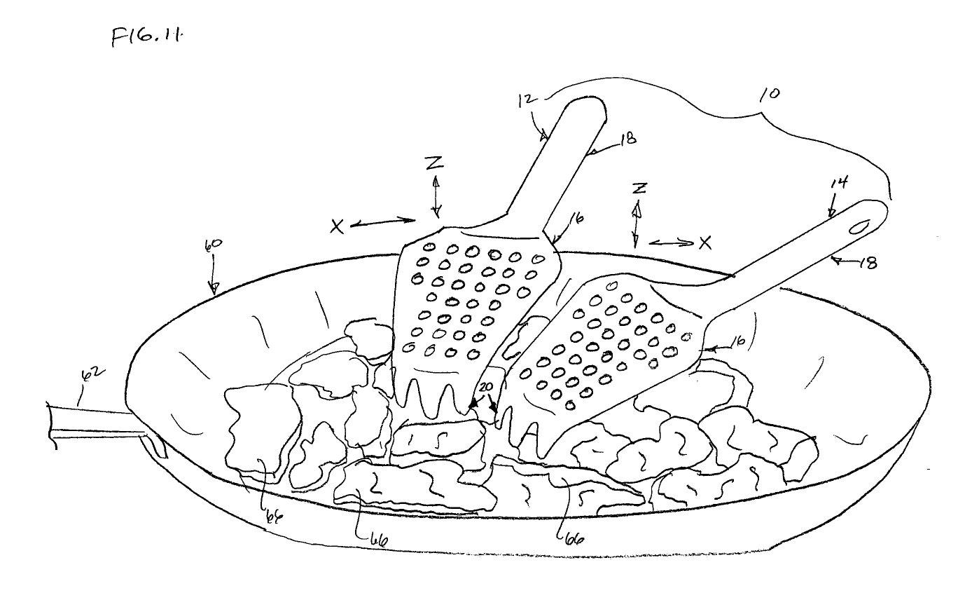

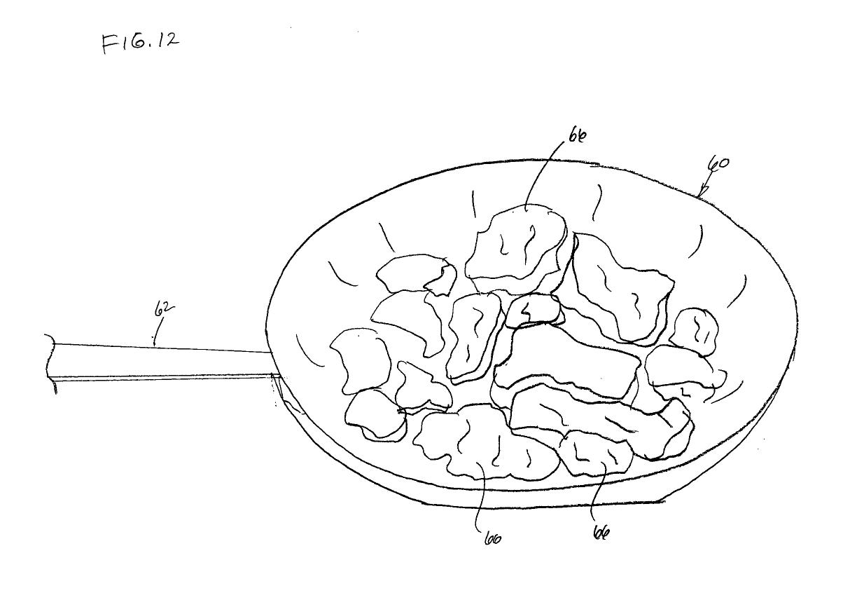

Referring now to FIGS. 9-18, an example food preparation assembly 10 is shown and described in the preparation of a food article 64 that is positioned within a pan 60 having a handle 62. Referring to FIG. 10, the user can take a separate one of the food preparation members 12, 14 in each hand. The food preparation members 12, 14 can be moved vertically in the Z direction into and out of the food article 64 to create holes in, claw and perforate the food article. With at least a portion of the claw portion 20 of each of the first and second food preparation members 12, 14 positioned within the food article 64, a user can apply a force having a horizontal component (i.e., in the X direction) typically moving the food preparation members 12, 14 in different directions thereby pulling apart the food article. This pulling apart motion can be repeated on the different food portions 66 that are created during this clawing, perforating, or pulling apart stage of food preparation. In at least some examples, the first and second preparation members 12, 14 can be rotated about the Z axis while the claw portion 20 is positioned within the food article 64 to further separate the food article 64 into food portions 66. FIG. 11 illustrates how the claw portion 20 can be used to create a plurality of food portions 66 as shown in FIG. 12 that have a smaller size than the original size of the food article 64 shown in FIG. 9.

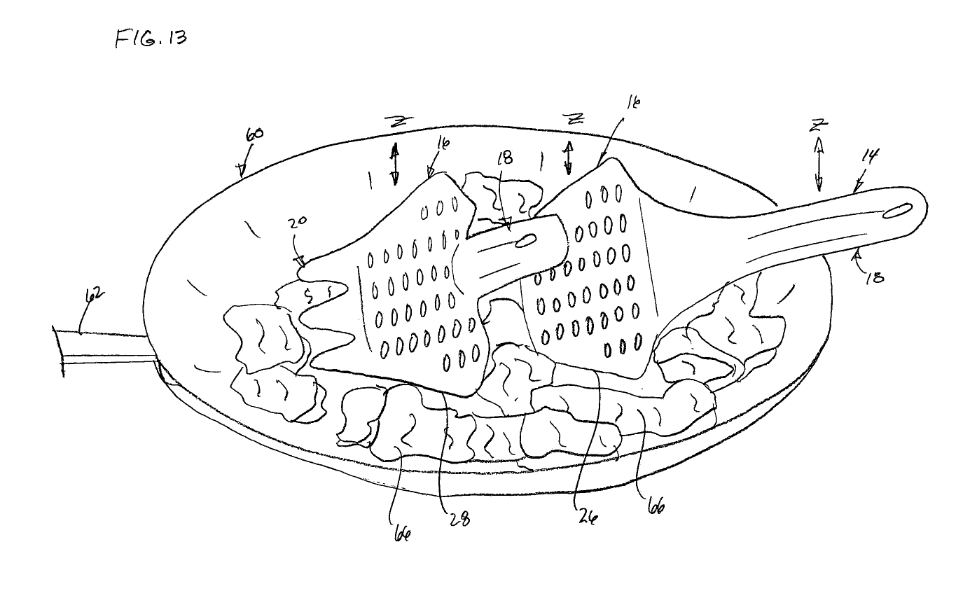

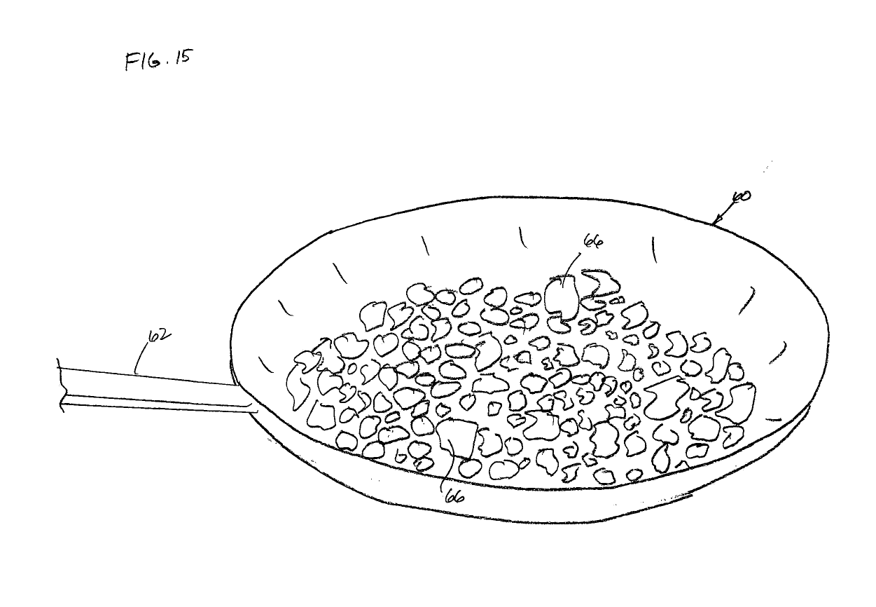

In the next stage of food preparation, FIG. 13 illustrates the first and second food preparation members 12, 14 arranged generally horizontally with one of the first and second side edges 26, 28 arranged facing the food portions 66. The user, while grasping the handle portions 18, can move the first and second food preparation members 12, 14 in a vertical direction Z to cut or chop the food portions 66 into smaller pieces. Each of the first and second food preparation members 12, 14 can be used to chop or cut the food portions 66. Alternatively, one of the food preparation members 12, 14 can be arranged as shown in FIG. 13 while the other of the food preparation members 12, 14 can be arranged as shown in FIGS. 10-11 to apply the claw portion 20 into the food portion 66. Using any combination of clawing or pulling and chopping or cutting using the arrangements shown in FIGS. 10-11 and 13-14 can be used to break the food article 64 down into even smaller size food portions 66 as shown in FIG. 15. The angled arrangement of the first and second side edges 26, 28 of the pad portion 16 can help elevate the handle portion 18 above the side of the pan 60 to reduce the possibility of the user contacting any portion of their hand against the pan 60 while performing the chopping/cutting action.

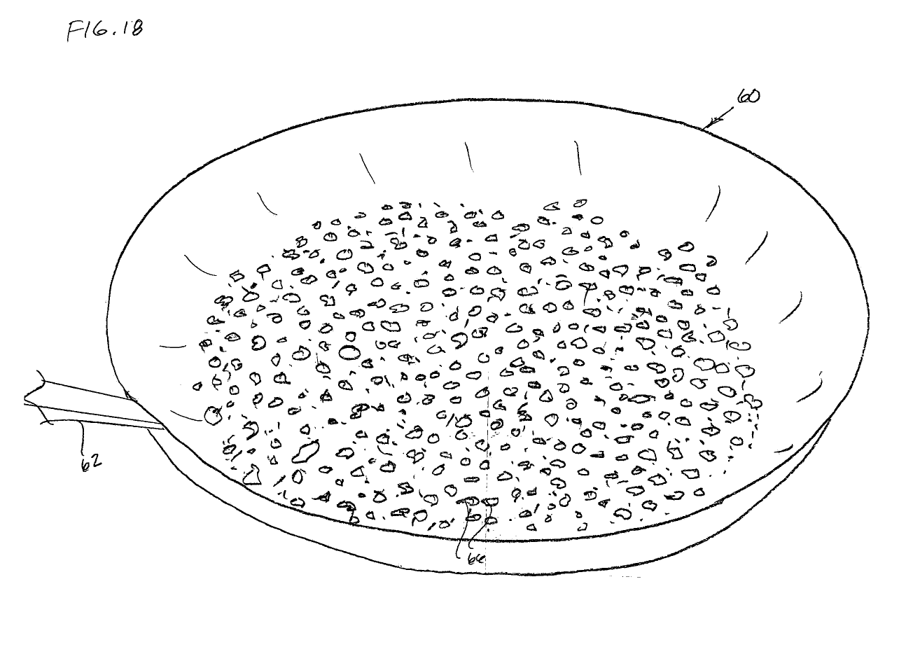

Referring now to FIGS. 16 and 17, the first and second food preparation members 12, 14 are repositioned so that the pad surfaces 30 are facing each other. The first and second food preparation members 12, 14 are moved towards each other in the X direction to capture at least some of the food portions 66 therebetween. With the pad surfaces 30 arranged generally parallel to each other, the user can move the first and second food preparation members 12, 14 generally in parallel with each other back-and-forth or side-to-side to compress the food portions 66. Applying a compressive force to the food articles while moving the first and second food preparation members 12, 14 relative to each other further breaks apart the food portion 66 to crumble and reduce the size of the food portion 66. At least some of the food portion 66 may pass through the apertures 34. Other of the food portions may drop from between the food preparation members 12, 14 back into the pan 60. Repeating this compressing and crumbling action upon the food portion 66 typically results in a relatively small, consistently sized food portions 66 as shown in FIG. 18.

Any of these steps shown and described with reference to FIGS. 9-18 may be performed on pre-cooked or completely cooked food. In some arrangements, the pan 60 may be heated so that cooking of the food article 64 can be completed concurrently with any of the clawing or pulling, chopping or cutting, or compressing or crumbling steps described with reference to FIGS. 9-18. Any one of the steps or functions described with reference to FIGS. 9-18 can be preformed independent of the other steps possible using the food preparation assembly 10. Furthermore, either one of the first and second food preparation members 12, 14 may be used alone to prepare the food article 64, or may be used with other types of cooking utensils in place of one of the food preparation members 12, 14.

Use of the food preparation assembly to prepare a food article in accordance with the above description can provide certain advantages such as, but not limited to, the following:
Reducing the overall cooking and preparation time of the food article.
More thoroughly cooking the food article thereby reducing the amount of bacteria and improving safety of the cooked food article.
Providing smaller sized food portions of the food article.
Providing improved consistency in the size of the food portions of the food article.
Promoting two-handed operation in preparing the food article using two separate food preparation members thereby reducing the time required to prepare the food article.
Increasing safety by not requiring that the cooking pan within which the food article was positioned to be used as part of the force or contact surface used to reduce the size of the food article in the smaller food portions.
Providing a food preparation member that is universal for left or right-handed individuals.
Providing a dishwasher safe food preparation device and assembly.
A food preparation assembly with two food preparation members that are stackable to provide improved compaction in storage.

The example food preparation assemblies described may be comprised of various materials. In one example, at least a portion of the food preparation members 12, 14 may comprise a polymeric material having heat resistance properties. In one example, an exterior surface of at least portions of the food preparation members includes a silicone based material. In other examples, at least portions of the food preparation members 12, 14 comprise a non-stick protective coating. Some examples may comprise a corrosion resistant material such as stainless steel.

The first and second food preparation members 12, 14 may be made using any of a variety of different manufacturing processes. For example, depending on the materials used, the food preparation members 12, 14 may be molded, stamped, formed, die-cut, caste or other manufacturing techniques.

Various inventive concepts have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” as used in the specification and claims shall have the same meaning as the term “comprising.”

What is claimed is:

1. A food preparation assembly, comprising:
first and second food preparation members each comprising a pad portion, a handle portion extending from a first end of the pad portion, and a claw portion extending from a second end of the pad portion, the pad portion defining an edge surface configured to chop food, the claw portion configured to pull apart food, and the pad portion defining a pad surface to compress food between the pad portions of the first and second food preparation members.

2. The food preparation assembly of claim 1, wherein the pad portion defines a plurality of holes through which at least some of the food passes when compressing the food between the pad portions.

3. The food preparation assembly of claim 1, wherein the claw portion defines at least two claw members.

4. The food preparation assembly of claim 3, wherein the claw members are arranged extending out of a plane defined by the pad surface.

5. The food preparation assembly of claim 1, wherein the handle portion extends out of a plane defined by the pad surface.

6. The food preparation assembly of claim 1, wherein the pad portion includes first and second side edges extending between the first and second ends, wherein the first and second side edges are arranged non-parallel with each other.

7. The food preparation assembly of claim 1, wherein the claw portion extends from the pad portion in an opposite direction relative to a direction in which the handle portion extends from the pad portion

8. The food preparation assembly of claim 1, wherein the pad surface includes at least one of plurality of protrusions or a plurality of recesses defined therein.

9. A method of preparing a food article, comprising:
providing a food preparation assembly, comprising:
first and second food preparation members that each comprise a pad portion, a handle portion extending from a first end of the pad portion, and a claw portion extending from a second end of the pad portion, the pad portion defining an edge portion;
pulling the food article apart using the claw portion of each food preparation member;
chopping the food article with the edge portion of each food preparation member;
compressing the food article between the pad portions of the food preparation member.

10. The method of claim 9, wherein pulling the food article apart includes inserting the claw portion of the first and second food preparation members into the food article and moving the first and second food preparation members in different direction relative to each other.

11. The method of claim 9, wherein chopping the food article includes inserting the edge portion of at least one of the first and second food preparation members into the food article.

12. The method of claim 9, wherein compressing the food article includes positioning a portion of the food article between the pad portions of the first and second food preparation members and moving the pad portions in different directions that are generally parallel relative to each other.

13. The method of claim 9, wherein compressing the food article includes positioning a portion of the food article between the pad portions of the first and second food preparation members and forcing at least some of the food article through at least one hole formed in the pad surface of at least one of the first and second food preparation members.

14. The method of claim 9, wherein portions of the food article become progressively smaller after performing the pulling, chopping, and compressing steps in series.

15. The method of claim 9, further comprising clawing the food article by inserting the claw portion of at least one of the first and second food preparation members into the food article.

16. A food preparation assembly, comprising:
a first food preparation member comprising a first pad portion, a first handle portion extending from a first end of the first pad portion, and a first claw portion extending from a second end of the first pad portion;
a second food preparation member comprising a second pad portion, a second handle portion extending from a first end of the second pad portion, and a second claw portion extending from a second end of the second pad portion;
wherein the first and second pad portions each define a chopping edge, the first and second claw portions are cooperatively operable to pull apart food, and the first and second pad portions are cooperatively operable to compress food between the first and second pad portions.

17. The food preparation assembly of claim 16, wherein at least one of the first and second pad portions includes a plurality of apertures defining a plurality of abrasive edges.

18. The food preparation assembly of claim 16, wherein the first claw portion defines at least two claw members that extend out of a plane defined by the first pad portion.

19. The food preparation assembly of claim 16, wherein the first handle portion extends out of a plane defined by the first pad portion.

20. The food preparation assembly of claim 16, wherein the first claw portion extends from the first pad portion in a common direction to a direction in which the first handle portion extends from the pad portion.
